(19) United States
(12) Patent Application Publication
(10) Pub. No.: US 2026/0178459 A1
(43) Pub. Date: Jun. 25, 2026

(54) ACCELERATOR DEBUGGING AND WATCHPOINTS WITH HARDWARE MONITORS

(71) Applicant: ADVANCED MICRO DEVICES, INC., Santa Clara, CA (US)

(72) Inventors: Mark Unruh Wyse, Bellevue, WA (US); Anthony Thomas Gutierrez, Seattle, WA (US)

(21) Appl. No.: 18/988,354

(22) Filed: Dec. 19, 2024

(51) Int. Cl. G06F 11/30

(52) U.S. Cl. CPC G06F 11/3037; G06F 11/3089

(57) ABSTRACT

Hardware monitoring circuitry is instantiated at various points in a processing system to monitor memory accesses and initiate a callback function in response to an access to a specified virtual addresses range. The specified virtual address range and the callback function are specified by a process such as an accelerator via a software application programming interface (API) that is independent of an architecture or instruction set architecture of the process. The processing system includes hardware monitors that are exposed to software executing at the processes via a software API that allows each of the processes to independently configure the hardware monitors to monitor specified accesses to the shared memory.

### BACKGROUND

To improve processing efficiency and conserve power, some processing systems employ one or more accelerators to perform designated operations on behalf of a central processing unit (CPU). For example, some processing systems employ a graphics processing unit (GPU) to perform graphics operations, an artificial intelligence (AI) accelerator to perform AI operations, a digital signal processor (DSP) to perform signal processing operations, and the like. However, while accelerators augment the compute capabilities of a processing system, many accelerators lack interfaces and infrastructure to enable effective runtime debugging.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system including hardware monitor circuitry for accelerator debugging in accordance with some embodiments.

FIG. 2 is a block diagram of hardware monitor circuitry for monitoring accesses to memory address ranges specified by a process independent of an architecture of the process in accordance with some embodiments.

FIG. 3 is a block diagram showing a hardware monitor coupled to a memory controller of an accelerated processing unit in accordance with some embodiments.

FIG. 4 is a block diagram showing hardware monitoring circuitry implemented at various points in a processing system including multiple accelerators in accordance with some embodiments.

FIG. 5 is a flow diagram illustrating a method for monitoring memory accesses by a hardware monitor programmed via a software interface in accordance with some embodiments.

### DETAILED DESCRIPTION

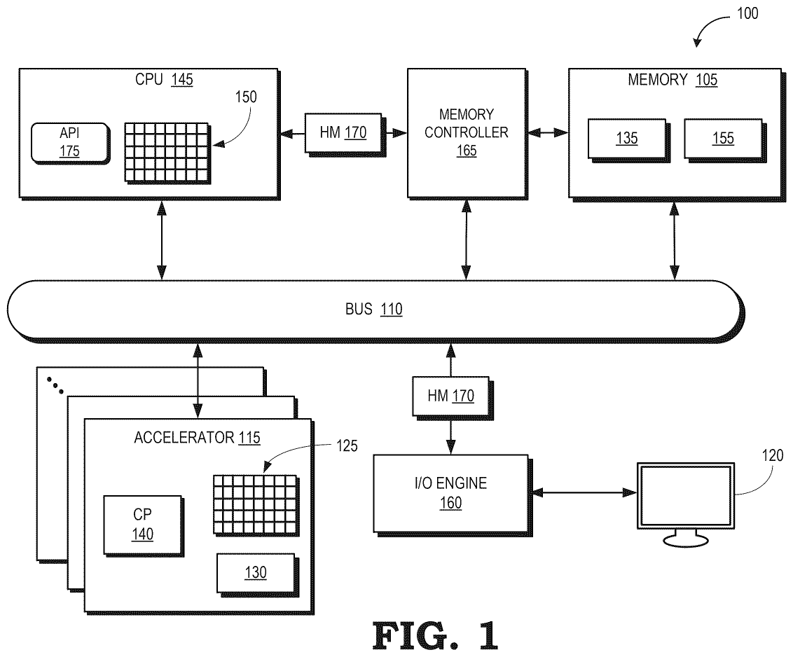

Successful accelerator deployment depends on debugging support, particularly for processing systems that incorporate first-and third-party accelerators in chiplet-based designs. Many accelerators either include insufficient debug support in the accelerator architecture or include debug mechanisms that are specific to the architecture of a particular accelerator, thus complicating debugging across a processing system that incorporates accelerators having diverse architectures or instruction set architectures (ISAs). FIGS. 1-5 illustrate techniques for incorporating hardware monitoring circuitry (also referred to herein as hardware monitors) at various points in a processing system to monitor memory accesses and initiate a callback function in response to an access to a specified virtual addresses range. The specified virtual address range and the callback function are specified by a process via a software application programming interface (API) that is independent of (i.e., agnostic to) an architecture or ISA of the process. Thus, an example processing system may include a host central processing unit (CPU) and an accelerator that execute different instruction sets but share memory. According to some embodiments, the processing system includes hardware monitors that are exposed to software executing at the CPU and the accelerator via a software API that allows each of the CPU and the accelerator to independently configure the hardware monitors to monitor specified accesses to the shared memory.

In some embodiments, the processing system includes a configurable number of hardware monitors based on performance targets, area requirements, and design resources. The hardware monitors are configurable to detect loads, stores, or both (e.g., atomic operations) to the specified virtual address range. In some embodiments, the virtual address range is represented as a base address and either an upper address limit or a range size. Thus, the granularity of the virtual address range is configurable and can range from a byte to a half-word (2 bytes) to a word (4 bytes) to a double word (8 bytes, or DWORD) size. In some implementations, the address range is larger than a DWORD.

The callback function initiated by the hardware monitor in response to an access to the specified virtual address range is also configurable. In some embodiments, the callback function is to notify the process that specified the virtual address (e.g., the CPU or the accelerator of the above example) of the access. Notification mechanisms include, for example, interrupts, sending a packet to a queue, and writing a signal. In other embodiments, the callback function is to notify a trap or other exception handler of the access. Although in some embodiments, each hardware monitor is programmable to monitor accesses to a single virtual address range and initiate a single callback function in response to an access to the specified virtual address range, in other embodiments, a hardware monitor is programmable to monitor accesses to multiple virtual address ranges and to initiate a callback function specific to each virtual address range in response to an access to any one of the specified virtual address ranges.

In some implementations, one or more accelerators are tightly integrated with a host processor (CPU) on a single die such as a chip or chiplet and one or more hardware monitors are integrated with a memory system interface of each accelerator. In other implementations, such as a chiplet-based system, a processing system includes one or more host processor chiplets, one or more accelerator chiplets, and one or more input/output (IO) or anchor die/chiplets having one or more memory controllers, in which hardware monitors are instantiated in the accelerator chiplet(s). For example, hardware monitors are instantiated in the one or more accelerator chiplets within a command processor complex or accelerator interface logic across which memory accesses must transit to reach the system memory. Alternatively, or in addition, one or more hardware monitors are instantiated in the IO or anchor die/chiplet. Such placement of the hardware monitor(s) provides centralized monitoring functionality that can observe and detect accesses to system memory that do not originate from the accelerator chiplets. The one or more accelerators may be integrated in the processing system as standalone devices such as PCIe-attached accelerator cards. In such implementations, the one or more hardware monitors are instantiated in the interface controllers or along the accelerator's access path to memory.

FIG. 1 is a block diagram of a processing system 100 configured to implement one or more architecture-independent hardware monitors to initiate a callback function in response to a memory access to a specified virtual address range in accordance with some embodiments. The processing system 100 is generally configured to execute sets of instructions (e.g., programs) or commands (e.g., draw commands) to carry out tasks on behalf of an electronic device. Accordingly, in different embodiments the processing system 100 is incorporated into one of a variety of electronic devices, such as a desktop computer, laptop computer, server, smartphone, tablet, game console, and the like.

The processing system 100 includes or has access to a system memory such as memory 105 or other storage component that is implemented using a non-transitory computer readable medium such as a dynamic random access memory (DRAM). However, the memory 105 can also be implemented using other types of memory including static random access memory (SRAM), nonvolatile RAM, and the like. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The processing system 100 includes one or more accelerators such as accelerator 115. An accelerator is a parallel processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The accelerator 115 can render objects to produce pixel values that are provided to the display 120. In some implementations, accelerators are separate devices that are included as part of a computer. In other implementations such as accelerated processing units (APUs), parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the accelerator 115 is also used for general-purpose computing. For instance, the accelerator 115 can be used to implement machine learning algorithms such as one or more implementations of a neural network as described herein. In some cases, operations of multiple accelerators 115 are coordinated to execute a machine learning algorithm, such as if a single accelerator 115 does not possess enough processing power to run the machine learning algorithm on its own. The multiple accelerator 115 communicate over one or more network interfaces (not shown in FIG. 1 in the interest of clarity) such as a network switch or other network device (e.g., a smart NIC).

The accelerators 115 implement multiple processing elements (also referred to as compute units) 125 that are configured to execute instructions concurrently or in parallel. Each of the accelerators 115 also includes an internal (or on-chip) memory 130 that includes a translation lookaside buffer (TLB) and a local data store (LDS), as well as caches, registers, or buffers utilized by the compute units 125. The internal memory 130 stores data structures that describe tasks executing on one or more of the compute units 125. In the illustrated embodiment, each accelerator 115 communicates with the memory 105 over the bus 110. However, some embodiments of the accelerators 115 communicate with the memory 105 over a direct connection or via other buses, bridges, switches, routers, and the like. The accelerators 115 can execute instructions stored in the memory 105 and the accelerators 115 can store information in the memory 105 such as the results of the executed instructions. For example, the memory 105 can store a copy 135 of instructions from a program code that is to be executed by the accelerators 115 such as program code that represents a machine learning algorithm or neural network. Each of the accelerators 115 also includes a command processor 140 that receives task requests and dispatches tasks to one or more of the compute units 125. The command processor 140 is a set of hardware configured to receive the commands from the CPU 145 and to prepare the received commands for processing. For example, in some embodiments the command processor 140 buffers the received commands, organizes the received commands into one or more queues for processing, performs operations to decode or otherwise interpret the received commands, and the like.

The processing system 100 also includes a central processing unit (CPU) 145 that is connected to the bus 110 and communicates with the accelerators 115 and the memory 105 via the bus 110. In the illustrated embodiment, the CPU 145 implements multiple processing elements (also referred to as processor cores) 150 that are configured to execute instructions concurrently or in parallel. The CPU 145 can execute instructions such as program code 155 stored in the memory 105 and the CPU 145 can store information in the memory 105 such as the results of the executed instructions. The CPU 145 is also able to initiate graphics processing by issuing commands or instructions (which are sometimes referred to herein as “draw calls”) to the accelerators 115.

An input/output (I/O) engine 160 handles input or output operations associated with the display 120, as well as other elements of the processing system 100 such as keyboards, mice, printers, external disks, and the like. The I/O engine 160 is coupled to the bus 110 so that the I/O engine 160 communicates with the memory 105, the accelerators 115, or the CPU 145.

In operation, the CPU 145 issues draw calls to the accelerators 115 to initiate processing of kernels that represent the program instructions that are executed by the accelerators 115. Multiple instances of the kernel, referred to herein as threads or work items, are executed concurrently or in parallel using subsets of the compute units 125. In some embodiments, the threads execute according to single-instruction-multiple-data (SIMD) protocols so that each thread executes the same instruction on different data. The threads are collected into workgroups that are executed on different compute units 125. For example, the command processor 140 can receive the draw calls and schedule tasks for execution on the compute units 125.

The programs executing at the processor cores 150 and the accelerators 115 access the memory 105 using virtual addresses in virtual address spaces, which are local address spaces that are specific to corresponding programs, instead of accessing the memory 105 using addresses based on the physical addresses of pages. As part of managing the physical locations of pages, a memory management unit (MMU) (not shown) translates the virtual addresses used by the programs in memory access requests into the physical addresses where the data is actually located and stores the translations at a page table, which is a record that includes entries with virtual address to physical address translation information for pages of data that are stored in the memory 105. Each process that is executing in the processing system 100 has a corresponding page table. The page table for a process translates the virtual addresses that are being used by the process to physical addresses in the memory 105. In some embodiments, the entirety of the page table for a process is stored in the memory 105. The memory controller 165 then uses the physical addresses to perform the memory accesses for the programs.

In addition, the processing system includes one or more translation lookaside buffers (TLBs) (not shown), which are local caches in each processor core or accelerator that store a limited number of copies of page table entries acquired during page table walks (or information based on page table entries). During operation, processor cores or accelerators first attempt to acquire cached page table entries from the corresponding TLB for performing virtual address to physical address translations. When the copy of the corresponding page table entry is not present in the TLB (i.e., when a “miss” occurs), the processor cores perform a page table walk to acquire the desired page table entry—and cache a copy of the acquired page table entry in the TLB.

To augment the debugging capabilities of the accelerators 115 and other components of the processing system 100, the processing system 100 includes a configurable number of hardware monitors 170. The hardware monitors 170 include hardware circuitry to monitor accesses to specified virtual address ranges. Software executing at a process such as the CPU 145, one or more of the accelerators 115, and the I/O engine 160 accesses functionality of the one or more of the hardware monitors 170 via an application programming interface (API 175). For example, in some implementations the API 175 exposes the presence of the one or more hardware monitors 170 to the software. Each process interacts with the hardware monitors 170 via the API 175 and configures one or more of the hardware monitors 170 to observe specified memory locations, detect memory operations (e.g., load, store, atomic read-modify-write) to the specified memory locations, and initiate a callback function such as notifying other system components or an exception handler when an access to the specified memory locations occurs. The hardware monitors 170 thus act as debugging watchpoints for accelerators 115 that do not include built-in hardware or software debugging support, or that include insufficient built-in hardware or software debugging support.

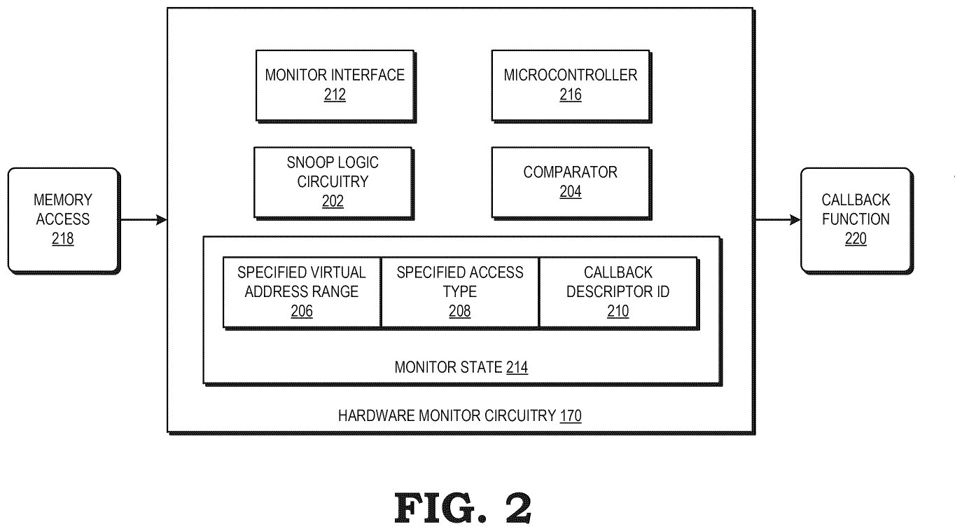

FIG. 2 is a block diagram of hardware monitor circuitry 170 for monitoring accesses to memory address ranges specified by a process independent of an architecture of the process in accordance with some embodiments. The hardware monitor circuitry 170 includes a monitor interface 212, snoop logic circuitry 202, a monitor state 214, and a comparator 204. In some embodiments, the hardware monitor circuitry 170 further includes a microcontroller 216. The monitor interface 212 is a software interface that allows the hardware monitor circuitry 170 to interact with the API 175. The monitor interface 212 receives commands from the accelerators 115 via the API 175 that program the monitor state 214 of the hardware monitor circuitry 170.

In some implementations, the monitor state 214 includes fields to store values of a specified virtual address range 206, a specified access type 208, and a callback descriptor ID 210 stored at registers or other storage of the hardware monitor circuitry 170. The specified virtual address range 206 includes a base virtual address and an upper limit virtual address in some implementations. In other implementations, the specified virtual address 206 includes the base virtual address and a range (e.g., the base virtual address plus a range of one byte, two bytes, one word, or two words). Thus, the granularity of the specified virtual address range 206 is configurable by the accelerator 115 or other component of the processing system 100 that programs the hardware monitor circuitry 170. The specified access type 208 is the type of memory access to the specified virtual address range 206 that triggers the hardware monitor circuitry 170 to initiate a callback function. For example, in some implementations, the specified access type is one or more of a read access, a write access, and an atomic read-modify-write access.

The callback descriptor ID 210 includes information specifying the callback function that the hardware monitor circuitry 170 is to initiate in response to an access of the specified access type 208 to the specified virtual address range 206. In some implementations, the callback descriptor ID 210 specifies the callback action that the hardware monitor circuitry 170 is to initiate, while in other implementations the callback descriptor ID 210 includes a pointer or handle to the callback action that the hardware monitor circuitry 170 is to fetch.

In some embodiments, the callback function identified by the callback descriptor ID 210 is to notify a process (such as the accelerator 115 that programmed the hardware monitor circuitry 170 or the host CPU 145) that the specified type of access to the specified virtual address range has occurred. In other embodiments, the callback function identified by the callback descriptor ID 210 is to invoke a trap handler or exception handler (also referred to herein as a fault/trap handler). In some embodiments, fault/trap handlers are registered with the hardware monitor circuitry 170 by, for example, assigning a meaning to the values written to the monitored address that are associated with the designated fault/trap handler. Thus, by encoding fault/trap handler identifiers in values written to the specified virtual address range, system software allows the hardware monitor circuitry 170 to execute different fault/trap handlers based on the values.

In some embodiments in which the accelerator 115 that programmed the hardware monitor circuitry 170 has sufficient debugging capabilities to detect an exception condition but insufficient capabilities to directly execute handling of a fault or exception, the accelerator 115 programs the hardware monitor circuitry 170 to monitor a specified virtual address range 206 to which the accelerator 115 writes a code in response to the exception condition. The code indicates the type of exception condition that has occurred and instructs the hardware monitor 170 either to directly execute an exception handler or trap handler (e.g., in embodiments in which the hardware monitor circuitry 170 includes the microcontroller 216) or to execute a callback that invokes exception handling at another component of the processing system 100 such as the host CPU 145. In embodiments in which the hardware monitor circuitry 170 directly executes the exception handler or the trap handler, the microcontroller 216 may execute the trap handler to access registers and other state associated with the accelerator 115 via a register access bus (not shown). The trap handler saves and restores the state, inspects the state, or instructs the compute units 125 of the accelerator 115 to inspect the code executing at the accelerator 115, e.g., by executing an instruction step or sequence of instructions step-by-step to facilitate debugging.

In some implementations, the monitor state 214 is configured to store only one specified virtual address range 206 and corresponding specified access type 208 and callback descriptor ID 210. However, in other implementations, the monitor state 214 is configured to store multiple specified virtual address ranges 206, each with a corresponding specified access type 208 and callback descriptor ID 210.

In operation, an accelerator 115 or other component of the processing system 100 programs the hardware monitor circuitry 170 via the API 175 and the monitor interface 212. The programming includes setting the monitor state 214 by storing values for the specified virtual address range 206, the specified access type 208, and the callback descriptor ID 210. Based on the monitor state 214, the snoop logic circuitry 202 monitors memory accesses such as memory access 218. The comparator 204 compares the virtual address of the memory access 218 to the specified virtual address range 206. If the virtual address of the memory access 218 matches the specified virtual address range 206, the comparator 204 compares the type of access of the memory access 218 to the specified access type 208. If the type of access of the memory access 218 matches the specified access type 208, the hardware monitor circuitry 170 executes a callback function 220 specified by the callback descriptor ID 210.

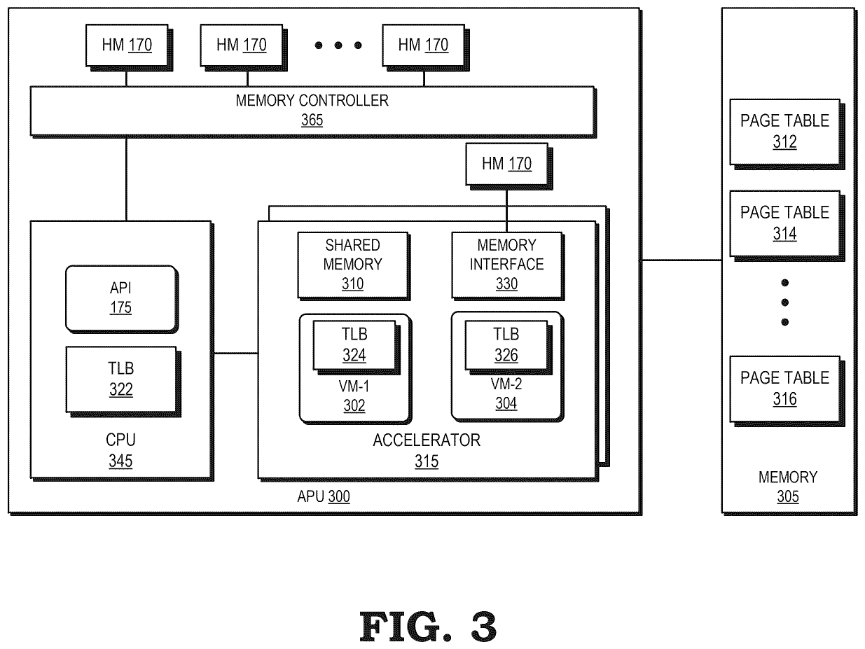

FIG. 3 is a block diagram showing accelerated processing unit (APU 300) with multiple instances of hardware monitor circuitry 170, in accordance with some embodiments. The APU 300 includes a CPU 345, one or more accelerators 315, and a memory controller 365. The memory controller 365 controls accesses to an off-chip memory 305. Each of the accelerators 315 further includes a shared memory 310 that includes a frame buffer and a local data store (LDS), as well as caches, registers, or other buffers utilized by the compute units in the accelerator 315, and a memory system interface 330 that allows the accelerator 315 to communicate with the memory controller 365. In the illustrated example, multiple instances of the hardware monitor circuitry 170 are communicatively coupled to the memory controller 365 and are configured to intercept memory transactions at the memory controller 365. In addition, an instance of the hardware monitor circuitry 170 is communicatively coupled to the memory system interface 330 of the accelerator 315.

In the illustrated example, the APU 300 utilizes virtualization to allow the sharing of physical resources of the APU 300 between different virtual machines (VMs) or guests. VMs are software abstractions of physical computing resources that emulate an independent computer system, thereby allowing multiple operating system environments to exist simultaneously on the same computer system. The host system (e.g., the APU 300) allocates a certain amount of its physical resources to each of the VMs so that each guest is able to use the allocated resources to execute applications. The virtual environment implemented on the host system also provides virtual functions to other virtual components implemented on a physical machine. A single physical function implemented in a physical resource of the host system such as a parallel processor is used to support one or more virtual functions (VFs). The single root input/output virtualization (SR-IOV) specification allows multiple VMs to share a physical resource interface to a single bus, such as a peripheral component interconnect express (PCIe) bus. Components access the virtual functions by transmitting requests over the bus.

In the illustrated example, two VMs (VM-1 302 and VM-2 304) are executing at the accelerator 315. Each of the CPU 345, VM-1 302, and VM-2 304 is referred to herein as a process and is allocated a portion of the virtual address space corresponding to the physical address space of the memory 305. Virtual-to-physical address translations used by the CPU 345, VM-1 302, and VM-2 304 to access locations in the memories 305, 310 (or other memories in the APU 300) are stored in page tables 312, 314, 316. The page tables 312, 314, 316 are allocated to different processes executing at the APU 300. If multiple processes are executing concurrently on the APU 300, the APU 300 generates and maintains multiple page tables to map the virtual address spaces of the concurrent processes to physical addresses in one or more of the memories 305, 310.

Translations that are frequently used by the CPU 345, VM-1 302, and VM-2 304 are stored in translation lookaside buffers (TLBs) 322, 324, 326 that are implemented in the CPU 345 and the accelerator 315, respectively. The TLBs 322, 324, 326 are used to cache frequently requested virtual-to-physical address translations. Entries including frequently used address translations are written from the page tables 312, 314, 316 into the corresponding TLBs 322, 324, 326. The CPU 345, VM-1 302, and VM-2 304 are therefore able to retrieve the address translations from the TLBs 322, 324, 326 without the overhead of searching for the translation in the page tables 312, 314, 316.

Each of the CPU 345, VM-1 302, and VM-2 304 has access to the instances of hardware monitor circuitry 170 via the API 175. In some embodiments, the API 175 manages the hardware monitor circuitry 170 to ensure that a given instance of the hardware monitor circuitry 170 is not made available to more than one process at a time. The API 175 exposes to each process which instance(s) of the hardware monitor circuitry 170 are available and each process selectively programs one or more instances of the hardware monitor circuitry 170 to watch for accesses to specified virtual memory addresses as described above with reference to FIG. 2. Whereas the instances of the hardware monitor circuitry 170 that are communicatively coupled to the memory controller 365 intercept transactions at the memory controller to monitor memory accesses, the instance of the hardware monitor circuitry 170 that is communicatively coupled to the memory system interface 330 of the accelerator 315 monitors memory transactions at the page tables 312, 314, 316 and the memory 310.

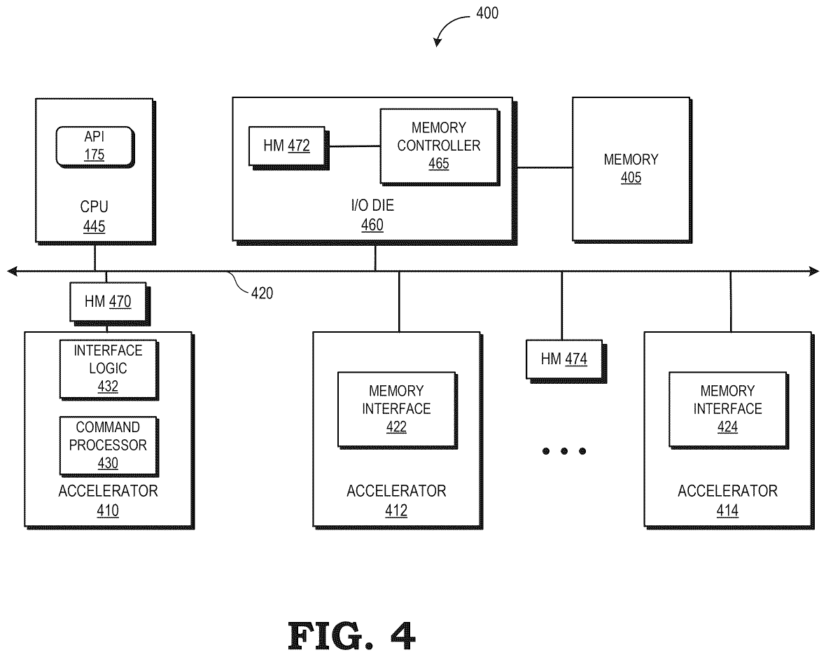

FIG. 4 is a block diagram showing hardware monitor circuitry implemented at various points in a chiplet-based processing system 400 including multiple accelerators in accordance with some embodiments. The processing system 400 includes a CPU 445, accelerator chiplets 410, 412, 414, a memory 405, and an I/O die 460 including one or more memory controllers 465. The processing system 400 includes a data fabric 420 that routes memory transactions to and from the I/O die 460 and the accelerator chiplets 410, 412, 414.

In the illustrated example, a first instance of hardware monitor circuitry 470 is integrated with accelerator chiplet 410. In some embodiments, the hardware monitor circuitry 470 is instantiated with a command processor 430 of the accelerator chiplet 410, and in other embodiments, the hardware monitor circuitry 470 is instantiated at accelerator interface logic 432 that memory accesses transit to reach the memory 405. From its integration with the accelerator chiplet 410, the hardware monitor circuitry 470 can observe memory transactions within the accelerator chiplet 410 (e.g., accesses to on-chip memory (not shown)) as well as memory transactions between the accelerator chiplet 410 and the memory 405.

A second instance of hardware monitor circuitry 472 is instantiated at the I/O die 460, where the hardware monitor circuitry 470 can detect accesses to memory that does not reside on one of the accelerator chiplets 410, 412, 414 themselves (i.e., accesses to memory 405). From its integration with the I/O die 460, the hardware monitor circuitry 472 observes memory transactions that flow through the data fabric 420, including memory transactions between accelerator chiplets 410, 412, 414, and from any of the accelerator chiplets 410, 412, 414 to the memory 405.

A third instance of hardware monitor circuitry 474 is instantiated as a standalone device such as a PCIe-attached accelerator card. The hardware monitor circuitry 474 is communicatively coupled to the data fabric 420, from which it observes memory transactions that flow through the data fabric 420, such as memory transactions between accelerator chiplets 410, 412, 414, and from any of the accelerator chiplets 410, 412, 414 to the memory 405.

In some embodiments, a number of instances of hardware monitor circuitry are implemented at various points in a processing system. For example, a processing system may include dozens or hundreds of (or more) instances of hardware monitor circuitry at different locations within the architecture of a processing system based on power performance, area requirements, and other design resources. The presence of each available instance of the hardware monitor circuitry is made visible to the other components of the processing system via the API 175, which allows the other components to program selected instances of the hardware monitor circuitry at runtime, using software executing at the other components.

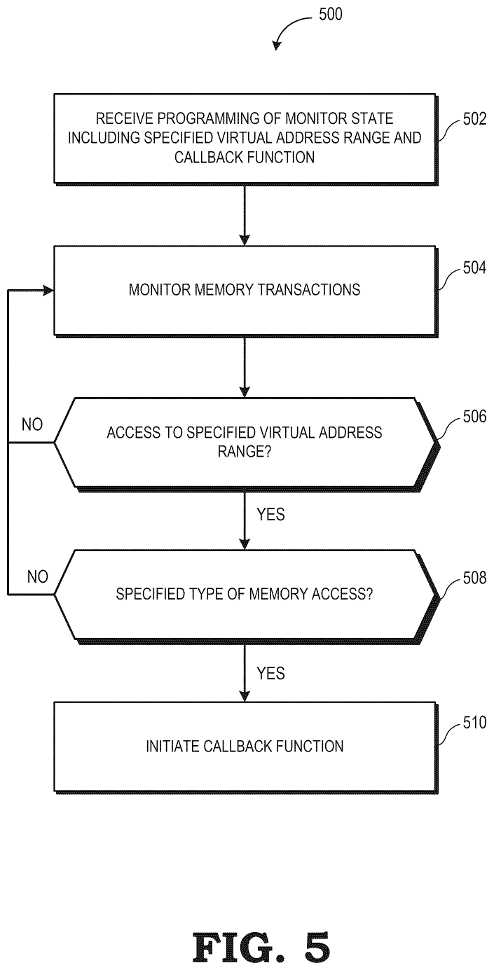

FIG. 5 is a flow diagram illustrating a method 500 for monitoring memory accesses by a hardware monitor programmed via a software interface in accordance with some embodiments. In some embodiments, the method 500 is performed by hardware monitor circuitry such as hardware monitor circuitry 170, 470, 472, or 474.

At block 502, the hardware monitor circuitry receives programming from a process of a processing system such as processing system 100. In some embodiments, the process is one of a CPU such as CPU 145, an accelerator such as accelerator 115, or an I/O engine, such as I/O engine 160 or I/O die 460. The programming programs a monitor state of the hardware monitor circuitry, and includes a specified virtual address range 206, a specified access type 208, and a callback descriptor ID 210 in some embodiments.

At block 504, the hardware monitor circuitry monitors memory transactions using snoop logic circuitry 202. Depending on where the hardware monitor circuitry is instantiated, the hardware monitor circuitry monitors memory transactions within a process such as an accelerator 315 or accelerator chiplet 410 and between the process and an external memory such as memories 105, 405, or memory transactions between multiple processes and/or an external memory.

At block 506, the hardware monitor circuitry compares a virtual address of an observed memory access such as memory access 218 to the specified virtual address range 206. In some embodiments, the comparator 204 compares the virtual address of the observed memory access 218 to the specified virtual address range 206. If the virtual address of the observed memory access 218 matches the specified virtual address range 206, the method flow continues to block 508. If the virtual address of the observed memory access 218 does not match the specified virtual address range 206, the method flow returns to block 504.

At block 508, the hardware monitor circuitry compares the memory access type of the observed memory access 218 to the specified access type 208. If the memory access type of the observed memory access 218 matches the specified access type 208, the method flow continues to block 510. If the memory access type of the observed memory access 218 does not match the specified access type 208, the method flow returns to block 504.

At block 510, the hardware monitor circuitry initiates a callback function described by the callback descriptor ID 210 for the specified virtual address range 206. In some embodiments, the callback function identified by the callback descriptor ID 210 is to notify a process that the specified type of access to the specified virtual address range has occurred. In other embodiments, the callback function identified by the callback descriptor ID 210 is to invoke a trap handler or exception handler. Depending on the capabilities of the hardware monitor circuitry (e.g., whether the hardware monitor circuitry includes a microcontroller such as microcontroller 216), the hardware monitor circuitry either performs the exception handling itself or invokes a fault or trap handler associated with the specified virtual address range 206.

In some embodiments, the apparatus and techniques described above are implemented in a system including one or more integrated circuit (IC) devices (also referred to as integrated circuit packages or microchips), such as the processing system described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
initiating, by a hardware monitor, a first callback function based on a first access to a first virtual address range matching a first specified virtual address range, wherein the first specified virtual address range is specified by a first process via an application programming interface (API).

2. The method of claim 1, wherein the first specified virtual address range comprises a base virtual address and at least one of an upper address limit and a range size.

3. The method of claim 1, wherein initiating the first callback function comprises notifying at least one of the first process and a trap handler of the first access.

4. The method of claim 1, wherein the first access comprises at least one of a load, store, or atomic operation.

5. The method of claim 1, wherein the first access is by an accelerator.

6. The method of claim 1, wherein the first specified virtual address range and the first callback function are programmable via the API.

7. The method of claim 1, further comprising:
based on a second access to a second virtual address range matching a second specified virtual address range, initiating, by the hardware monitor, a second callback function.

8. A system comprising:
a memory; and
hardware monitor circuitry configured to:
initiate a first callback function based on a first access to a first virtual address range matching a first specified virtual address range of the memory, wherein the first specified virtual address range is specified by a first process via an application programming interface (API).

9. The system of claim 8, wherein the first specified virtual address range comprises a base virtual address and at least one of an upper address limit and a range size.

10. The system of claim 8, wherein the hardware monitor circuitry is further configured to notify at least one of the first process and a trap handler of the first access.

11. The system of claim 8, wherein the first access comprises at least one of a load operation, a store operation, and an atomic operation.

12. The system of claim 8, wherein the first access is by an accelerator.

13. The system of claim 8, wherein the first specified virtual address range and the first callback function are programmable via the API.

14. The system of claim 8, wherein the hardware monitor circuitry is further configured to:
based on a second access to a second virtual address range matching a second specified virtual address range, initiate a second callback function.

15. A system comprising:
a host processor; and
a plurality of hardware monitors, wherein each hardware monitor of the plurality of hardware monitors is configured to initiate a callback function based on an access to a virtual address range matching a specified virtual address range, wherein the specified virtual address range is specified by a process via an application programming interface (API).

16. The system of claim 15, wherein:
a first hardware monitor of the plurality of hardware monitors is configured to initiate a first callback function based on a first access to a first virtual address range matching a first specified virtual address range; and
a second hardware monitor of the plurality of hardware monitors is configured to initiate a second callback function based on a second access to a second virtual address range matching a second specified virtual address range.

17. The system of claim 16, wherein:
the first hardware monitor is further configured to notify a first process of the first access; and
the second hardware monitor is further configured to notify a second process of the second access.

18. The system of claim 16, wherein each of the first access and the second access comprise at least one of a load operation, a store operation, and an atomic operation.

19. The system of claim 16, wherein:
the first access is by a first accelerator; and
the second access is by a second accelerator.

20. The system of claim 15, wherein the specified virtual address range and the callback function for each hardware monitor of the plurality of hardware monitors are programmable.
